(19) United States
(12) Patent Application Publication
(10) Pub. No.: US 2026/0093935 A1
(43) Pub. Date: Apr. 2, 2026

(54) Mobile Devices and Methods for Energizing Radiofrequency Tags

(71) Applicant: Zebra Technologies Corporation, Lincolnshire, IL (US)

(72) Inventors: Ohad Shatil, Dunwoody, GA (US); Somesh Agrawal, Westbury, NY (US); Satyendra Bhaisare, Woodside, NY (US)

(73) Assignee: Zebra Technologies Corporation, Lincolnshire, IL (US)

(21) Appl. No.: 19/327,362

(22) Filed: Sep. 12, 2025

Related U.S. Application Data
(60) Provisional application No. 63/701,343, filed on Sep. 30, 2024.
(60) Provisional application No. 63/719,883, filed on Nov. 13, 2024.

(51) Int. Cl. G06K 7/00; G06K 7/10

(52) U.S. Cl. CPC G06K 7/0008; G06K 7/10099

(57) ABSTRACT

A method includes: obtaining operational data corresponding to a mobile computing device; comparing the operational data to a criterion, and determining, based on the comparison, whether to initiate a radio frequency (RF) tag read operation. In response to a determination to initiate the RF tag read operation, the method further includes obtaining at least one identifier from an RF tag, and sending the at least one identifier to a computing device.

### CROSS-REFERENCE TO RELATED APPLICATIONS

This application claims priority from U.S. Provisional Patent Application No. 63/701,343, filed Sep. 30, 2024, and from U.S. Provisional Patent Application No. 63/719,883, filed Nov. 13, 2024. The entire contents of each of the above-referenced applications is incorporated herein by reference.

### BACKGROUND

In a facility storing, processing, and/or otherwise handling items such as packages, apparel, or the like (e.g., retail facilities, warehouses, and the like), radiofrequency (RF) tags may be affixed to at least some of the items. The RF tags may contain item identifiers and/or other item-related data. In some facilities, fixed tag-reading infrastructure can be deployed to capture data from the above tags for subsequent processing. Deploying such infrastructure can be costly and time-consuming.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of a facility containing mobile computing devices and RF tags.

FIG. 2 is a diagram of certain components of a mobile computing device of FIG. 1.

FIG. 3 is a flowchart of a method for energizing RF tags from mobile devices.

FIG. 4 is a diagram of an example performance of blocks 305 and 310 of the method of FIG. 3.

FIG. 5 is a diagram of an example performance of block 325 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method comprising: obtaining operational data corresponding to a mobile computing device; comparing the operational data to a criterion; determining, based on the comparison, whether to initiate a radio frequency (RF) tag read operation; in response to a determination to initiate the RF tag read operation, obtaining at least one identifier from an RF tag; and sending the at least one identifier to a computing device.

Additional examples disclosed herein are directed to a mobile computing device comprising: a communications interface; and a processor configured to: obtain operational data corresponding to a mobile computing device; compare the operational data to a criterion; determine, based on the comparison, whether to initiate a radio frequency (RF) tag read operation; in response to a determination to initiate the RF tag read operation, obtain at least one identifier from an RF tag; and send the at least one identifier to a computing device.

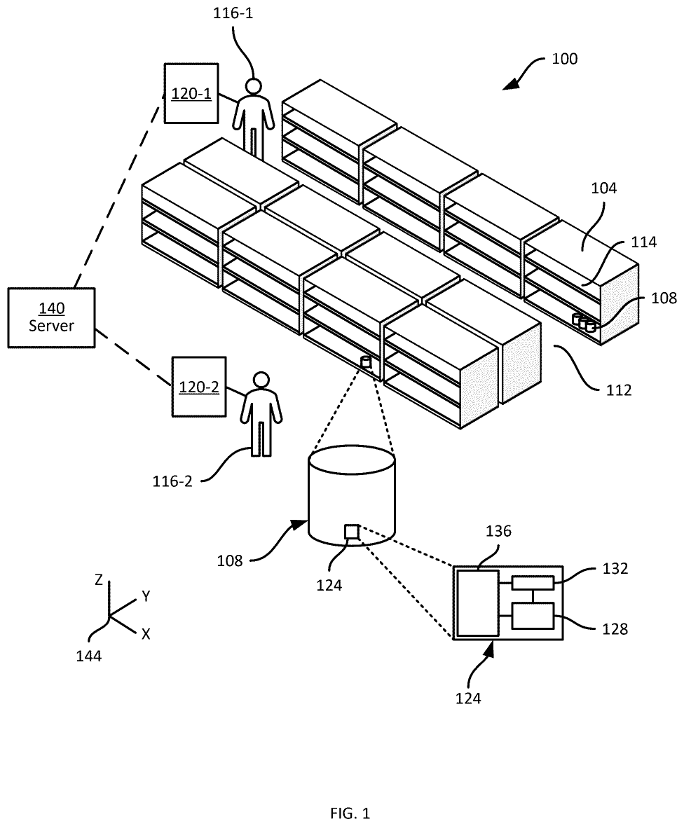

FIG. 1 illustrates an interior of a facility 100, such as a warehouse, a manufacturing facility, a healthcare facility, or the like. The facility 100 includes a plurality of support structures 104 carrying items 108. In the illustrated example, the support structures 104 include shelf modules, e.g., arranged in sets forming aisles 112. In the examples shown in FIG. 1, the support structures 104 include support surfaces 114 supporting the items 108. The support structures 104 can also include pegboards, bins, tables, or the like, in other examples. In some examples, the support structures 104 can include portions of a floor of the facility 100, in addition to or instead of distinct structures disposed on the floor, such as the shelf modules shown in FIG. 1. The facility 100 can have a wide variety of layouts and sizes than the example shown in FIG. 1.

The items 108 may be handled according to a wide variety of processes, depending on the nature of the facility. In the examples discussed below, the facility 100 is a fulfillment facility or the like, and the items 108 disposed on the support structures 104 can be retrieved for shipping from the facility 100 to fulfill incoming orders each indicating identifiers of certain items. The retrieval of an item 108 from a support structure 104 is also referred to as a pick operation. Picks can be performed in the facility 100 by one or more pickers 116-1, 116-2 (collectively referred to as the pickers 116, and generically referred to as a picker 116; similar nomenclature may be used herein for other components with hyphenated reference numbers), such as human workers. Various numbers of pickers can be deployed in the facility 100, e.g., depending on the size of the facility 100, the rate at which orders are received for fulfillment, and the like. Each picker 116 can operate a mobile computing device 120, such as a tablet computer, a smartphone, a wearable computer, or the like. The devices 120 enable the presentation of information to the pickers 116, the capture of information from the picker 116, e.g., indicating completion of a pick task, or the like.

The nature of the workers 116 in the facility and the devices 120 operated by the workers 116 can vary with the type of the facility. For example, in a retail facility, the items 108 may be retrieved from the support structures 104 by customers, and the workers 116 may be staff responsible for stocking the support structures 104.

The facility 100 can contain a plurality of RF tags 124. For example, at least some of the items 108, and in some examples up to all of the items 108, are associated with RF tags. Instead of, or in addition to, the items 108, tags 124 can be disposed on fixed structures within the facility 100, such as the support structures 104 or the like. For example, as shown in FIG. 1, an item 108 can include an RF tag 124 embedded within the item 108, affixed to an exterior of the item 108, or the like. The tag 124 is a passive tag, reliant on energizing radiation from one or more energizing devices. As will be apparent to those skilled in the art, the tag 124 can include a chip 128, e.g., including a non-volatile memory storing an identifier such as a unique tag identifier. The tag 124 can also include an energy storage device 132 such as a capacitor or the like. Further, the tag 124 can include an antenna 136. The antenna 136 is configured to harvest energy from transmissions by the above-mentioned energizing device(s), for storage in the storage device 132.

The tags 124, in this implementation, are ambient RF tags (also referred to as ambient Internet of Things (IoT) tags). An ambient RF tag 124 is configured to harvest energy from “ambient” wireless transmissions over a variable period of time. That is, a given tag 124 can harvest and store energy from wireless transmissions emitted by one or more devices in the facility 100 over a period of seconds, minutes, or in some cases longer periods of time. When the tag 124 has harvested sufficient energy to generate a transmission, the tag 124 can emit a signal containing any of a wide variety of data stored on the tag 124. The data transmitted by a tag 124 can include an identifier of the tag 124, and in some implementations can include sensor data collected by the tag (e.g., temperature, motion data, or the like). That is, a data transmission by a tag 124 need not be performed in response to an interrogation signal or any specific energizing signal. Further, the data transmission need not be directed to any particular device in the vicinity of the tag 124 (e.g., such as the device that energized the tag 124).

As will be apparent to those skilled in the art, the processes described herein can also be applied to other forms of RF tags, such as passive radiofrequency identification (RFID) tags reliant on concurrent energizing and data collection by a given tag-reading device, rather than ambient energizing (potentially from more than one device over the time period(s) mentioned above) decoupled from data transmission.

Energy stored in the device 132 permits the chip 128 to retrieve the above-mentioned identifier (or any other suitable data stored in the chip 128) and transmit the data from the antenna 136. The transmissions used to energize the tag 124 can be in different frequency bands than the transmissions generated by the antenna 136 in response to becoming energized. For example, the transmissions emitted by other devices to energize the tag 124 can have frequencies of about 900 MHz, or frequencies in another suitable portion of the Ultra-High Frequency (UHF) band. The transmissions generated by the tag 124 can be Bluetooth™ Low Energy (BLE) transmissions and/or Wi-Fi transmissions, e.g., with a frequency of around 2.4 GHz.

The tags 124 can be employed for inventory tracking, for example to ascertain the quantity and/or locations of items 108 within the facility. In some examples, inventory tracking can be extended to automated checkout functionality, e.g., by detecting that an item has left the facility with a customer based on changes in the item's location over time. Tracking the presence and/or location of a tag 124 involves periodically reading the tag, e.g., emitting radiation in the UHF band to energize the tag 124, and receiving one or more BLE transmissions from the tag 124. Various other functions can also be implemented by the tags 124, e.g., for environmental monitoring in the facility 100.

Various fixed infrastructure can be deployed in facilities such as the facility 100 to perform the above-mentioned tag reading operations. Tag-reading infrastructure can include tag readers (e.g., referred to as bridges) affixed at various locations within the facility 100 (e.g., walls, ceilings, support structures 104, and the like). The tag-reading infrastructure can also include one or more gateway devices installed in the facility 100. The bridges in such facilities can be configured to collect tag identifiers, and transmit the identifiers to one or more gateway devices (e.g., via wireless links such as Bluetooth). The gateway device(s), in turn, can be configured to transmit the collected tag identifiers to other computing devices, such as on-site or off-site servers, via local and/or wide-area networks.

The above-mentioned fixed infrastructure can be costly and time-consuming to deploy and maintain. As described below, the mobile computing devices 120 are configured to implement tag-energizing and data capture functionality, to supplement or replace such fixed infrastructure. The devices 120 are configured to periodically emit signals to energize nearby tags 124. The devices 120 are further configured to capture data transmitted by the tags 124 in response to being energized (whether by the same device(s) 120 capturing the data or by one or more different devices 120). The devices 120 can further transmit collected tag data to a server 140, e.g., via a wireless local-area network (WLAN) or other suitable networking infrastructure, for further processing.

Although replacing the above-mentioned fixed infrastructure (e.g., a set of bridge devices for energizing the tags 124 and capturing data therefrom, and one or more gateway devices for relaying tag data from the bridges to a computing device such as the server 140) with the mobile devices 120 may simplify the implementation of tag energizing and data capture functionality in the facility 100, the devices 120 are subject to various constraints that may affect their performance in energizing the tags 124 and/or capturing data from the tags 124. For example, the devices 120 can be operated to perform a wide variety of functions aside from energizing the tags 124 and capturing data therefrom, and under some conditions, a given device 120 may have insufficient computational resources to accommodate tag-related operations. Further, the devices 120 are battery-powered, and may therefore in some cases have insufficient stored energy levels to perform tag-related operations without interrupting other operations. As discussed below, each device 120 can therefore implement functionality to assess available resources at the device 120 (and optionally, at other nearby devices 120), and in some examples positional data corresponding to the device 120. Positional data can include, for example, a location of the device, e.g., within a facility coordinate system 144.

Each device 120 can further be configured to determine whether or not to perform tag-related operations (e.g., emitting signals to energize the tags 124 and/or listening for data transmissions from the tags 124) based on the assessment. In some examples, each device 120 can also set parameters that control the tag energizing signals mentioned above based on available resources at the device 120, and/or on positional data corresponding to the device 120.

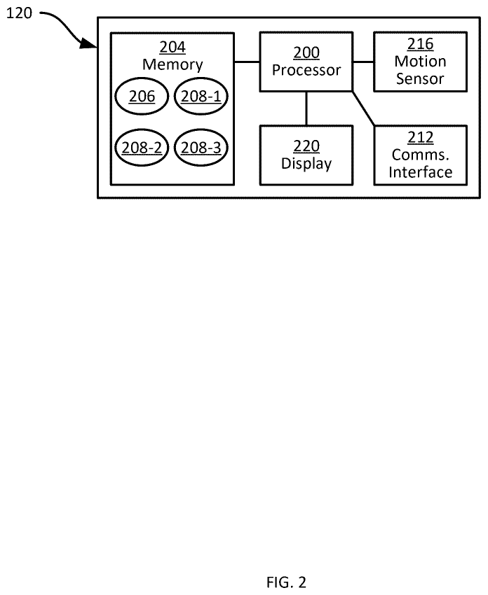

Before discussing the functionality implemented by the devices 120, certain components of the devices 120 are discussed in connection with FIG. 2. Each device 120 can include the components shown in FIG. 2 and discussed below, although it will be understood that the specific implementations of those components may vary between devices 120. For example, while the devices 120 may each include a display, the devices 120 can include different types and/or sizes of display panel.

As shown in FIG. 2, the device 120 includes a processor 200, e.g., one or more central processing units (CPUs), graphics processing units (GPUs), or dedicated hardware controllers such as application-specific integrated circuits (ASICs). The processor 200 is communicatively coupled with a non-transitory computer readable medium such as a memory 204, e.g., a suitable combination of volatile and non-volatile memory elements. The memory 204 stores computer-readable instructions executable by the processor 200 to implement functionality for energizing the tags 124 and capturing data from the tags 124 as described below, e.g., in the form of an application 206. The memory 204 can store additional applications 208-1, 208-2, 208-3, and the like, e.g., for performing functions unrelated to tag reading (e.g., applications for messaging, barcode scanning, timekeeping, and the like).

The processor 200 is also coupled with a communications interface 212, enabling the device 120 to communicate with other computing devices, such as the server 140, other devices 120, and the like. The communications interface 212 can include a plurality of transceivers and associated antennas, e.g., each implementing one or more communication technologies. For example, the communications interface 212 can include suitable hardware (e.g., antennas, transceivers, and the like), along with suitable software (e.g., firmware, driver applications and the like) to communicate over one or more of WLANs (e.g., based on Wi-Fi standards), personal area networks (PANs) implemented via Bluetooth or the like, and cellular networks. The communications interface 212 can also include suitable components for performing tag read operations as noted earlier.

The device 120 further includes a motion sensor 216, such as an inertial measurement unit (IMU) including one or more accelerometers, one or more gyroscopes, or the like. The motion sensor 216 can be configured to determine an orientation of the device 120, e.g., as pitch, yaw, and roll angles relative to gravity (e.g., relative to vertical). The motion sensor 216 can also be configured to track movement of the device 120. The processor 200 can be configured to integrate data from the motion sensor 216 with data from the communications interface 212, image sensors (not shown), or the like, to track a location of the device 120 within the coordinate system 144. Various mechanisms will occur to those skilled in the art for location tracking, e.g., via beacons mounted within the facility, optical markers disposed within the facility at predetermined locations, and the like.

The device 120 can also include input and output components, such as a display 220 integrated with a touch panel. The device 120 can include a wide variety of other inputs and outputs, in addition to or instead of the display 220. For example, the device 120 can include inputs such as buttons, keypads, microphones, or the like, and/or outputs such as speakers, indicator lights, and the like. The components of the device 120 can be powered by an onboard battery (not shown), e.g., a rechargeable battery.

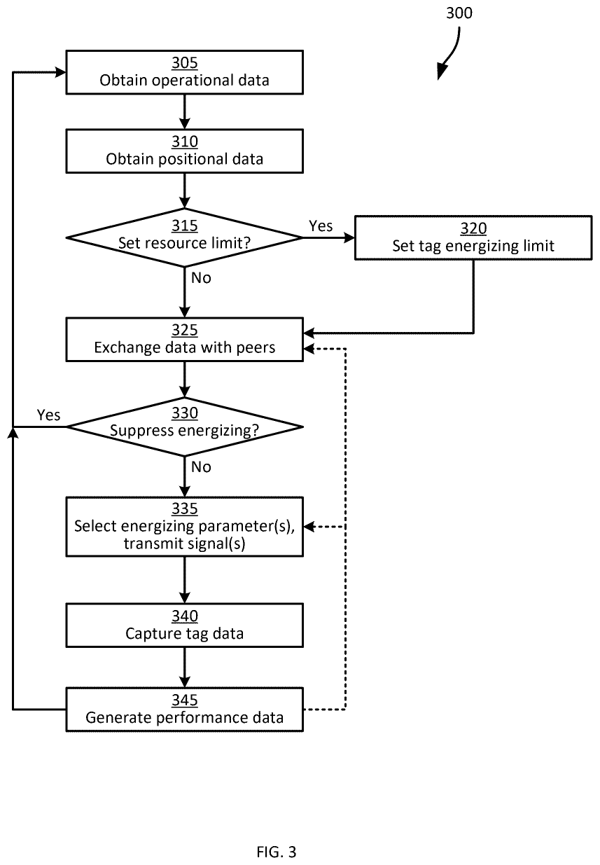

Turning to FIG. 3, a method 300 of energizing the RF tags 124 and capturing data from the tags 124 from a mobile device 120 is illustrated. The method 300 is described below in conjunction with its performance by the processor 200 of a device 120, e.g., via execution of the application 206 by the processor 200, and/or by equivalent dedicated hardware elements as noted earlier. It will be understood that a plurality of devices 120 deployed in the facility 100, up to and including each of the devices 120 in the facility 100, can perform distinct instances of the method 300. As will be apparent to those skilled in the art, performance of the method 300 permits a device 120 to implement either or both of the above-mentioned bridge and the above-mentioned gateway, mitigating or obviating the need for fixed deployment of such devices in the facility 100, while also mitigating the impact of such functions on the performance of other tasks by the device 120.

At block 305, the device 120 is configured to obtain operational data. The operational data reflects local availability of computational resources, at the device 120 itself. For example, the operational data can include a current battery charge level. The operational data can further include a utilization level for the processor 200. The utilization level can be, for example, an average over the previous ten seconds (or any other suitable time period), or can be an instantaneous measurement at the time that block 305 is performed. The operational data can further include indicators of which applications 208 are currently being executed by the processor 200.

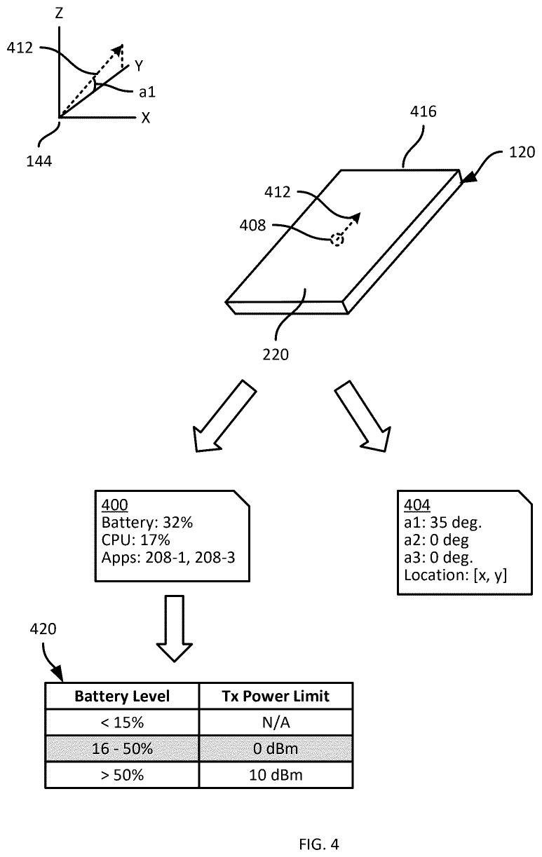

At block 310, the device 120 can obtain positional data corresponding to the location and/or orientation of the device 120, e.g., within the facility 100. The processor 200 can, for example, obtain a location and orientation of the device 120 from the motion sensor 216, e.g., defined in the coordinate system 144. FIG. 4 illustrates example operational data 400 and positional data 404. The operational data 400, in this example, indicates a current battery charge level (e.g., 32%, although it will be understood that the battery charge level can be expressed in forms other than a percentage), a utilization level for the processor 200 (which can also be expressed in other forms than a percentage), and identifiers of active applications 208. Thus, in this example, the processor 200 is currently executing the applications 208-1 and 208-3, but not the application 208-2. The positional data 404 indicates a location of the device 120, e.g., expressed as X and Y coordinates of a centroid 408 of the device 120 in the coordinate system 144. The Z coordinate may be omitted as the devices 120 travel along a floor of the facility 100 with the workers 116. The positional data 404 can also indicate angles, in any suitable unit, of a direction 412 of the device, defined relative to the centroid 408 (e.g., parallel to the display 220 and pointing towards a top 416 of the device). The angle a1, for example, indicates that the device 120 is tilted relative the to Y axis by 35 degrees (e.g., rotated about the X axis by 35 degrees).

The positional data can also include other data, such as a velocity of the device 120. For example, the velocity can represent an average direction (in the coordinate system 144) and speed of the device 120 over the preceding five seconds. The operational data 400, the positional data 404, or both, can be timestamped.

Returning to FIG. 3, at block 315 the processor 200 is configured to determine whether to set a resource usage limit for the next tag energizing operation. The determination at block 315 can include comparing the operational data (e.g., at least a portion thereof) to one or more criteria. The determination at block 315 serves to determine whether the device 120 has sufficient resources to perform a tag energizing operation without significantly impacting other operations at the device 120. The criterion can include, for example, a battery level threshold, such that if the current battery level is below the threshold, the determination at block 315 is affirmative. In other examples, the criterion can include a processor utilization threshold, instead of or in addition to the battery level threshold, such that it the processor utilization exceeds the threshold, the determination at block 315 is affirmative. In further examples, the criterion can include a number of applications 208, or identifiers of specific applications 208. If the number of applications 208 actively being executed, or if the specifically identified applications 208 are active, the determination at block 315 is affirmative.

If two or more of the above criteria are applied at block 315, the determination at block 315 may be affirmative if any one (or more) of the criteria are met (that is, if the battery is low, or if processor utilization is high). As will be apparent, the above criteria assess whether performing a tag energizing operation is likely to disrupt the other operations of the device 120. For example, if the battery charge level is low (e.g., smaller than the threshold mentioned above), performing tag read operations may increase the likelihood of exhausting the battery, necessitating replacement of the battery, placement of the device 120 in a charging cradle, or the like.

When the determination at block 315 is affirmative, at block 320 the processor 200 is configured to set a tag energizing limit. The tag energizing limit can include a restriction on the maximum transmit power level used for tag energizing signals later in the method 300, and/or a restriction on the maximum duty cycle used for the transmission of tag energizing signals. As will be apparent, the transmit power and duty cycle (e.g., the proportion of a given time period that the communications interface is used to transmit the energizing signals) may impact the amount of energy stored in the device's battery, as well as other wireless transmissions being sent or received by the device 120. Applying a maximum to either of the above parameters can mitigate negative impacts of tag energizing operations on other concurrent operations at the device 120.

The limit(s) set at block 320 can be set based on configuration data defined in the application 206. For example, in some implementations the limit may prevent the tag energizing operation entirely. That is, if the determination at block 315 is affirmative, e.g., because the device 120 has too little remaining battery power, a significant computational load, or the like, the limit can be set to zero, preventing the use of any device resources for tag energizing operations. In other examples, the limit(s) set at block 320 can vary proportionally with the operational data, or based on a predetermined set of thresholds defined in the application 206. For example, referring again to FIG. 4, configuration data 420 is shown including a set of transmit power limits (e.g., in dBm, although it will be understood that other units, and other limits, can be defined). The configuration data 420 also includes, for each power limit, a battery level threshold, such that a transmit power limit can be selected by comparing the current battery level to those thresholds. As seen in the example of FIG. 4, a battery level of 32% results in the selection of the 0 dBm (equivalent to 1 mW) transmit power limit. The configuration data 420 can also include duty cycle limits based on the illustrated thresholds. In further examples, the configuration data can include thresholds for not only battery levels, but also processor utilization levels, application activity indicators, or combinations thereof.

Returning to FIG. 3, at block 325 the device 120 can be configured to exchange data with one or more other devices 120 (which may be referred to as peer devices) in the vicinity of the device 120. Peer data exchange can be conducted, for example, via BLE or other suitable short-range wireless communications, and can therefore be limited in range to those devices 120 that are within a threshold distance of each other. For example, the communications technology and transmission power used for the data exchange at block 325 can be selected to exchange data with peer devices 120 that are within about 20 m of the device 120. A wide variety of other thresholds can also be implemented.

The data exchanged at block 325 can include at least a portion of the operational data from block 305, and/or at least a portion of the positional data from block 310. In some examples, performance data and/or tag read results from previous performances of the method 300 can also be exchanged at block 325. Exchanging data at block 325 can include either or both of transmitting data to other devices 120, and receiving data from other devices 120. The transmission and reception of data at block 325 need not be sequenced with blocks 305 to 315 as shown in FIG. 3. For example, block 325 can be performed periodically, e.g., at a predetermined frequency, by each of the devices 120, and the data broadcast by each device 120 can be timestamped. For subsequent blocks of the method 300 that make use of peer device data, the device 120 can be configured to retrieve the most recently-received peer data, for example.

At block 330, the device 120 is configured to determine whether to suppress a tag energizing operation, based on the operational data from block 305 and data received from other devices 120 at block 325. The determination at block 330 can also, in some cases, be based on the positional data from block 310. As will be apparent to those skilled in the art, because the devices 120 are mobile, multiple devices 120 may be in the same area of the facility 100 at the same time. When multiple devices 120 are within a certain proximity (e.g., within a threshold distance of one another), each of those devices 120 may be in a position to energize the same, or substantially the same, set of nearby tags 124. Energizing those tags 124 by multiple devices at the same time may be inefficient (e.g., consuming more power collectively between the devices 120 than is necessary to harvest enough energy to permit the tags 124 to transmit tag data). The devices 120 can therefore exchange and evaluate data to determine which device 120 will perform a tag energizing operation, and which devices 120 will not.

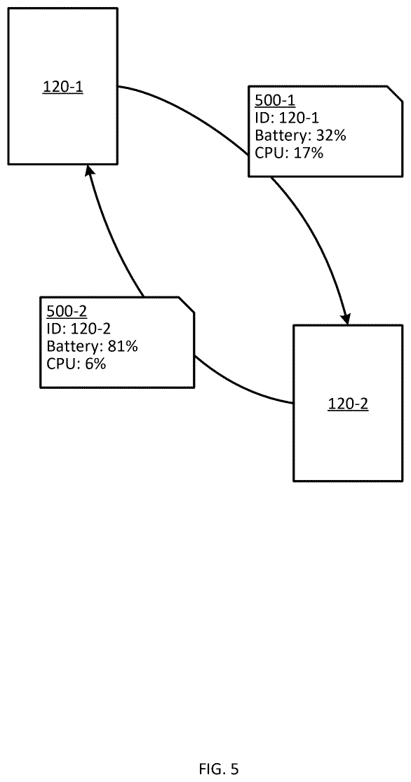

The determination at block 330 can include, for example, comparing the operational data 400 to operational data from another device 120 to determine which device 120 is better suited to perform the tag energizing operation. For example, referring to FIG. 5, the devices 120-1 and 120-2 are shown exchanging data. In particular, the device 120-1 is shown transmitting peer data 500-1 to the device 120-2, and receiving peer data 500-2 from the device 120-2. The peer data 500 can be contained in a capabilities message according to any suitable standard.

The peer data 500 includes, in this example, an identifier of the transmitting device 120, as well as battery levels and processor utilization levels. The data 500 can also include other operational data, and/or positional data in some implementations. For example, the devices 120 can exchange locations (e.g., coordinates in the coordinate system 144), and at block 330 the device 120-1 can determine whether the devices 120-1 and 120-2 are within a threshold distance of one another. If the device 120-2 is further away than the threshold distance from the device 120-1, the determination at block 330 is negative, irrespective of the operational data exchanged at block 325.

The device 120-1 can be configured to compare operational data by, for example, determining which of the devices 120-1 and 120-2 has a greater battery capacity, and/or which of the devices 120-1 and 120-2 has a lower processor utilization level. When more than one attribute of operational data is compared (e.g., battery level and processor utilization), the device 120-1 can be configured to generate a combined score, e.g., by generating a weighted average or sum of the attributes. The scores of each device 120 can then be compared. In further examples, the peer data 500 itself can include the above-mentioned score, instead of the individual attributes of operational data.

When the device 120-2 has a greater battery level, for example (or, in other examples, a lower processor utilization level) than the device 120-1, the determination at block 330 is affirmative. Otherwise, the determination at block 330 is negative. That is, when the device 120-1 determines that another device 120 in the vicinity has onboard resources better able to accommodate tag energizing operations (e.g., more stored energy, more available computational cycles, or the like), the device 120-1 is configured to suppress performance of a tag energizing operation of its own. When, on the other hand, the device 120-1 determines that no other device 120 in the vicinity (that is, none of the other devices 120 for which peer data 500 was received at block 325) has onboard resources better able to accommodate tag energizing operations, the determination at block 330 is negative.

When the determination at block 330 is affirmative, the device 120 (in the example of FIG. 5, the device 120-1) returns to block 305, without performing a tag energizing operation. Conversely, in the instance of the method 300 performed contemporaneously by the device 120-2, the determination at block 330 is negative, the device 120-2 proceeds to block 335.

At block 335, the device 120 performing a tag energizing operation selects one or more energizing parameters for the energizing portion of the tag energizing operation. For example, as noted earlier, the energizing parameters can include a transmit power level and a duty cycle. Other example energizing parameters may also occur to those skilled in the art.

The device 120 can be configured to select the energizing parameters based on one or more of the operational data from block 305, the positional data from block 310, and any limits set at block 320. For example, the device 120 can maintain configuration data that defines, for a plurality of battery level thresholds, corresponding transmit power levels (e.g., descending transmit power levels for descending battery levels) for the tag energizing operation. In examples using both battery level and processor utilization, the configuration data can define descending transmit power levels for ascending processor utilization. Further, battery level and processor utilization can be combined, via weighted sum, and the configuration data can define successive transmit power levels for various combined battery level and processor utilization levels). Similarly, the configuration data can define descending duty cycle parameters for descending battery levels, and/or ascending processor utilization levels, and/or combined levels as noted above.

In further examples, selecting energizing parameters can also be based on the location and/or orientation and/or velocity of the device 120. For example, the device can select or modify transmit power levels for tag energizing operations based on predefined device velocities (e.g., when the device 120 is travelling more quickly through the facility, higher transmit power and duty cycle parameters can be employed, reflecting the fact that the device 120 has less time to capture tag data in any given location).

In some examples, evaluating a plurality of attributes, such as a battery level, a processor utilization level, a location of the device 120, an orientation of the device 120, and the like, can lead to complex decision trees that may be difficult to maintain. The device 120 can, in some examples, implement one or more machine learning-based classification algorithms to process the above attributes and output energizing parameters. For example, the device 120 can implement a classifier (e.g., within the application 206) that accepts a vectorized combination of the above-mentioned attributes as input, and outputs a transmit power level and duty cycle, or a class identifier corresponding to a predefined transmit power level and duty cycle. The model can, in some examples, be trained substantially in real time using performance data generated following tag energizing operations as feedback, e.g., to optimize the selection of energizing parameters to improve performance and/or minimize resource consumption at the device 120. In some examples, the selected energizing parameters can be compared to any limits from block 320, and reduced to those limits if the selected energizing parameters exceeded the limits.

At block 335, the device 120 is configured to perform a tag energizing operation using the selected parameters. That is, the processor 200 is configured to control the communications interface 212 to emit one or more energizing signals (e.g., via a UHF antenna). As will be apparent to those skilled in the art, in some examples the performance of the method may end following block 335. For example, it is possible that tags 124 in the vicinity of the device 120 emitting energizing signals are not sufficiently energized to transmit tag data. Those tags 124 may, for example, harvest and store some energy from the signals emitted at block 335, and await further energizing signals before transmitting tag data.

In other examples, whether in response to the energizing signals transmitted at block 335 or in response to energizing signals from other sources, one or more tags 124 in the vicinity of the device 120 may transmit tag data. At block 340, the device 120 can be configured to capture tag data from one or more tags 124, e.g., including tag identifiers from those tags 124. The tags 124 may have transmitted their respective tag data in response to being energized by the above signals from block 335, but may also have been energized by other sources. Further, in some examples, the device 120 can proceed to block 340 following a negative determination at block 330. In further examples, after setting a tag energizing limit of zero at block 330, the device 120 can proceed directly to block 340, bypassing blocks 325 to 335. That is, a device 120 can determine based on its operational data that it will not perform a tag energizing operation, but can still listen for tag data transmitted by tags 124 that have been energized by other sources.

The device 120 can also be configured to relay each unique tag identifier collected at block 340 (as will be apparent, each tag 124 may transmit multiple packets of data containing the same identifier, dependent on how long the tag 124 remains energized, and/or on how frequently the tag 124 is able to harvest sufficient energy to begin transmitting tag data) to the server 140.

At block 345, the device 120 is configured to generate performance data based on the tag data collected at block 340. For example, for each tag identifier received at block 340, the device 120 can be configured to generate one or more performance attributes. The performance attributes can include a received signal strength indicator (RSSI) for the corresponding tag identifier. If more than one response was received from the same tag 124, the RSSI can be an average of the received responses, or the lowest RSSI value.

The performance attributes can also include one or more timing measurements, including for example a time between emission of the energizing signal by the device 120, and receipt of the first response from the given tag 124. Another example timing measurement can include an average time between responses for the given tag 124, when more than one response was received from that tag 124.

The device 120, in subsequent performances of block 335, can modify energizing parameters based on performance data from block 345. As noted above, for example, if the device 120 implements a machine learning-based classifier, the performance data can be provided to the classifier as feedback, such that over time, the classifier learns which energizing parameters yield greater performance attributes associated with the tags 124 (e.g., at different locations in the facility 100, for different operational data for the device 120, or the like).

In other examples, when the selection of energizing parameters is performed via sets of thresholds or the like, the performance data from block 345 can be used to determine an adjustment to apply to the threshold-based energizing parameters. For example, given a particular transmit power level and duty cycle, the device 120 can be configured to increment the transmit power level and duty cycle if the performance data from a preceding performance of block 345 indicates performance below a threshold (e.g., average tag RSSI below a threshold).

The performance data can also be included in peer data 500 sent to other devices 120. For example, any tag identifiers collected at block 340 can be included in the peer data 500-1, optionally accompanied by the corresponding RSSI values. The determination at block 330 as performed by the device 120-1 can therefore also include, for example, a comparison of tag identifiers detected in a previous performance of block 340 with tag identifiers in the peer data 500-2. If the tag identifiers match (that is, the devices 120-1 and 120-2 detected the same set of tags 124 in a previous operation), the device 120 can proceed with a determination at block 330 as discussed earlier. If the devices 120-1 and 120-2 detected different (even if overlapping) sets of tags 124, the determination at block 330 can be negative, irrespective of the operational data in the peer data 500.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
obtaining operational data corresponding to a mobile computing device;
comparing the operational data to a criterion;
determining, based on the comparison, whether to initiate a radio frequency (RF) tag energizing operation;
in response to a determination to initiate the RF tag energizing operation, transmitting an energizing signal;
obtaining at least one identifier from an RF tag; and
sending the at least one identifier to a computing device.

2. The method of claim 1, wherein the operational data comprises at least one of:
a battery level of the mobile computing device,
a processor utilization level of the mobile computing device, or
an indication of at least one application executed by the processor.

3. The method of claim 1, wherein determining whether to initiate the RF tag read operation comprises:
when the operational data does not meet the criterion, setting a resource limit corresponding to the RF tag read operation.

4. The method of claim 3, wherein the resource limit includes a maximum transmission power for the RF tag read operation.

5. The method of claim 3, wherein the operational data comprises a battery level of the mobile computing device;
wherein the criterion comprises a battery level threshold; and
wherein determining whether the operational data meets the criterion includes determining whether the battery level exceeds the threshold.

6. The method of claim 1, wherein determining whether to initiate the RF tag read operation comprises:
when the operational data does not meet the criterion, determining not to initiate the RF tag read operation.

7. The method of claim 1, further comprising:
obtaining positional data corresponding to the mobile computing device;
in response to a determination to initiate the RF tag read operation, selecting a tag energizing parameter based on the positional data.

8. The method of claim 7, wherein the positional data comprises at least one of:
a location of the mobile computing device,
an orientation of the mobile computing device, or
a velocity of the mobile computing device.

9. The method of claim 7, further comprising:
in response to obtaining the at least one identifier from the RF tag, determining tag read performance data corresponding to the RF tag; and
selecting the tag energizing parameter based on the tag read performance data.

10. The method of claim 1, further comprising:
obtaining, at the mobile computing device, from a second mobile computing device in proximity to the mobile computing device, operational data corresponding to the second computing device; and
determining, based on the operational data corresponding to the second computing device, whether to suppress the RF tag read operation.

11. A mobile computing device comprising:
a communications interface; and
a processor configured to:
obtain operational data corresponding to a mobile computing device;
compare the operational data to a criterion;
determine, based on the comparison, whether to initiate a radio frequency (RF) tag read operation;
in response to a determination to initiate the RF tag read operation, obtain at least one identifier from an RF tag; and
send the at least one identifier to a computing device.

12. The method of claim 11, wherein the operational data comprises at least one of:
a battery level of the mobile computing device,
a processor utilization level of the mobile computing device, or
an indication of at least one application executed by the processor.

13. The method of claim 11, wherein the processor is configured to determine whether to initiate the RF tag read operation by:
when the operational data does not meet the criterion, setting a resource limit corresponding to the RF tag read operation.

14. The method of claim 13, wherein the resource limit includes a maximum transmission power for the RF tag read operation.

15. The method of claim 13, wherein the operational data comprises a battery level of the mobile computing device;
wherein the criterion comprises a battery level threshold; and
wherein the processor is configured to determine whether the operational data meets the criterion by determining whether the battery level exceeds the threshold.

16. The method of claim 11, wherein the processor is configured to determine whether to initiate the RF tag read operation by:
when the operational data does not meet the criterion, determining not to initiate the RF tag read operation.

17. The method of claim 11, wherein the processor is configured to:
obtain positional data corresponding to the mobile computing device;
in response to a determination to initiate the RF tag read operation, select a tag energizing parameter based on the positional data.

18. The method of claim 17, wherein the positional data comprises at least one of:
a location of the mobile computing device,
an orientation of the mobile computing device, or
a velocity of the mobile computing device.

19. The method of claim 17, wherein the processor is configured to:
in response to obtaining the at least one identifier from the RF tag, determine tag read performance data corresponding to the RF tag; and
select the tag energizing parameter based on the tag read performance data.

20. The method of claim 11, wherein the processor is configured to:
obtain, at the mobile computing device, from a second mobile computing device in proximity to the mobile computing device, operational data corresponding to the second computing device; and
determine, based on the operational data corresponding to the second computing device, whether to suppress the RF tag read operation.
